(19) United States
(12) Patent Application Publication
(10) Pub. No.: US 2018/0329520 A1
(43) Pub. Date: Nov. 15, 2018

(54) wrist support device

(71) Applicant: Cheryl Mazak, London (CA)

(72) Inventor: Cheryl Mazak, London (CA)

(73) Assignee: Cheryl Mazak, London, CA (US)

(21) Appl. No.: 15/731,706

(22) PCT Filed: Jan. 22, 2016
(86) PCT No.: PCT/IB2016/050327

§ 371 Date: Jul. 19, 2017

Related U.S. Application Data
(60) Provisional application No. 62/106,819, filed on Jan. 23, 2015.

(51) Int. Cl. G06F 3/039; A63F 7/36

(52) U.S. Cl. CPC G06F 3/039; A63F 7/3603; A63F 7/0632; G06F 2203/0332; A63F 2250/495

(57) ABSTRACT

The present invention relates generally to a device and methods for enhancing the proper ergonomics of the hand and wrist when using a keyboard, mouse, magic track pad, computer peripheral, writing instrument, or game controller such as a video game controller or an air hockey paddle. The wrist support device, according to the present invention, is comprised of an external pivot joint having an exterior surface that is rounded along a transverse axis and an interior coupling cavity configured to couple to a cushion. The cushion permanently attaches to the interior coupling cavity throughout the life of the cushion, which is most typically a number of months. The cushion releasably attaches to a human's hand or wrist for use when the person is working on a computer or performing other tasks such as typing, using a computer mouse, magic track pad that may cause a narrowing of the carpal tunnel or impinge blood flow to the median nerve, such as game playing or using peripheral controllers or devices.

### CROSS-REFERENCE TO RELATED APPLICATIONS

This application claims priority to the following U.S. Provisional Patent Applications: Provisional Patent Application No. 62/106,819, entitled “Carpal Tunnel Assist Device,” filed on Jan. 23, 2015; and Provisional Patent Application No. 62/117,977, entitled “Carpal Tunnel Assist Device,” filed on Feb. 19, 2015, the entire contents of which are hereby incorporated by reference.

### FIELD

The present invention relates generally to a device and methods for enhancing the proper ergonomics of the hand and wrist when using a keyboard, mouse, computer peripheral, or game piece such as an air hockey paddle.

### BACKGROUND

In present day society, people spend large amounts engaged with some sort of a computer. This engagement typically involves, typing, using a computer mouse, and other hand movements that can cause pain, fatigue or a strain to the delicate tendons and nerves located within the hand, forearm and wrist. Aside from computers, there are games that individuals play that also cause strain to the hands, forearms and wrists. For example, holding air hockey paddles for an extended period of time requires flexion of the wrist that impinges blood flow to the median nerve.

The physiology of the hand is, not surprisingly, very complex given the enormous amount of structures and dexterity in the human hand. The carpal tunnel is a passageway in the wrist through which nerves and the long tendons of the flexor muscles of the wrist and forearm and fingers pass. The median nerve is a nerve that is formed by the union of the medial and lateral roots from the medial and lateral cords of the brachial plexus. The median nerve is the only nerve that passes through the carpal tunnel. It supplies the muscular branches in the anterior region of the forearm and the muscular and cutaneous branches in the thumb, first two fingers and medial portion of the third finger of the hand.

There are nine flexor tendons that pass through the carpal tunnel, along with the median nerve. If the tendons become overused and inflamed or swollen, the carpal tunnel narrows and can put pressure on the median nerve. If the median nerve becomes impinged, it can result in a condition known as carpal tunnel syndrome.

Carpal tunnel syndrome is a type of repetitive strain injury, which can affect any person who performs repetitive motions of the forearm, wrist, or fingers for extended periods of time. One of the primary causes of carpal tunnel syndrome is extended periods of computer use. Humans using computers, whether for work or pleasure, perform thousands of repetitive motions on keyboards and computer peripherals such as a mouse for many hours each day. Carpal tunnel syndrome can develop and worsen from repetitive motions such as typing, using a computer mouse, computer peripherals, gaming pieces such as an air hockey paddle or handwriting.

FIG. 1 shows classic positioning of the hand and wrist when using a computer mouse. Although not shown, those of skill in the art will recognize that a similar impingement of the wrist occurs when people type on a keyboard. As can be seen in FIG. 1, the median nerve, which runs through the center of the wrist, is impinged due to the unnatural bend in the individual's wrist. This type of positioning results in a narrowing of the space in the carpal tunnel. In turn, the nerves and tendons within the carpal tunnel become compressed from the stretched flexor tendons that run through the carpal tunnel, which can result in inflammation of the nerves and tendons.

If an individual develops Carpal Tunnel Syndrome, they will experience symptoms including include numbness, tingling, and burning pain in the palm and fingers of the hand. At first, these symptoms may be transitory. But with prolonged exposure to ergonomically incorrect positioning of the hands, wrists, or fingers, an individual will begin to feel symptoms even when he or she is not working on a computer. In severe cases, carpal tunnel syndrome can cause weakness, difficulty gripping objects and loss of sensation. If left untreated, carpal tunnel syndrome can require surgical intervention, which involves cutting through the connective tissue (flexor retinaculum) on the anterior surface of the palm of the hand, which is also known as the palmar surface.

To address this physiological issue, those of skill in the art have developed support devices such as pads to create an ergonomically proper alignment of the wrist when one is typing or using a computer mouse. One such example is U.S. Pat. No. 6,219,867 entitled “Cushion Pad with Enhanced Cushionability,” (“'867 patent”), the entire contents of which are hereby incorporated by reference. The '867 patent is directed toward a keyboard wrist pad, which is designed to rest in a stationary position in close proximity to a keyboard. The '867 patent is not designed to support the wrist or hand when a user is using a mouse, nor is it designed to move dynamically with a user's hands as he or she changes hand position for typing or computer game play.

In contrast, U.S. Pat. No. 6,932,304 entitled “Wrist Support Device,” (“'304 patent”), the entire contents of which are hereby incorporated by reference, is directed to providing wrist support to computer users when they are using their mouse. The '304 patent discloses a mouse wrist pad that is part of a mouse housing. The mouse housing holds the mouse in a stationary position so as to create proper dimensional ergonomics between the mouse and the wrist pad. Similarly, U.S. Pat. No. 8,451,225 entitled “Computer Mouse Cushion” (“'225 patent”), the entire contents of which are hereby incorporated by reference, is also directed to a support pad that is affixed to a computer mouse in order to provide support to the hand and wrist of the user.

The static positioning of the mouse and wrist pads disclosed in the '304 and '225 patents may be beneficial for a user performing routing word processing tasks where using a computer mouse is infrequent and rather banal. For video game play, artistic applications, or word processing requiring selecting and highlighting large sections of documents, however, having a static mouse that is unable to move within a zone of movement is too restrictive to be practical.

Similarly, U.S. Pat. No. 7,861,984, entitled “Anatomic Support for Hand and Wrist,” (“'984 patent”) and U.S. Pat. No. 8,851,431, which is a continuation-in-part of the '984 patent, entitled “Anatomic Support for Hand,” (“'431 patent”), the entire contents of both are hereby incorporated by reference, are directed to a stand-alone support pad for the hand and wrist. While the pads of the '984 and '431 patents are not affixed to a mouse or keyboard, they are nonetheless designed to be stationary.

Although the '304, '225, '984, and '431 patents provide wrist support to users, the stationary nature of these designs can cause additional health issues related to users keeping their hands/muscles in the same position for extended periods of time. Accordingly, there is a need for a wrist support device that facilities proper ergonomic positioning for keyboard and mouse use, while allowing the freedom of hand movement required by gaming, artistic endeavors, music creation, and complex mouse or magic track pad tasks.

### SUMMARY OF THE INVENTION

The wrist support device, according to the present invention, is comprised of an external pivot joint having an exterior surface that is rounded along a transverse axis and an interior coupling cavity configured to couple to a cushion. The cushion is reusable and can attach to the interior coupling cavity by virtue of an adhesive being applied to the surface of the cushion that comes in contact with the interior coupling cavity. The cushion releasably attaches to a human's hand or wrist for use when the person is working on a computer or performing other tasks that may impinge blood flow to the median nerve, such as game playing using peripheral controllers or devices.

The adhesive used to make the cushion releasably attachable to human skin is strong enough to make a connection that will allow the wrist support device to attach, while being gentle enough to allow the user to easily remove the wrist support device without causing damage to the individual's skin. In one embodiment, the adhesive that could be used to make the cushion releasably attachable could be a double coated high performance medical grade acrylic adhesive with a polyethylene carrier on a 54# C2S paper differential release liner. Over time, the adhesive properties of the portion of the cushion that is releasably attached to a human's hand, wrist, or forearm may diminish. When this happens, the cushion of the wrist support device can be replaced.

In one embodiment, there is claimed a wrist support device comprising an external pivot joint, wherein the external pivot joint further comprises (a) an exterior that is rounded along at least a transverse axis; (b) a rigid exterior surface; and (c) an interior coupling cavity for attaching a cushion; and a cushion configured to attach to the interior coupling cavity and to releasably attach to a human hand or wrist.

In an alternate embodiment, the wrist support device includes curvature along the transverse axis that is generally circular.

In yet an alternate embodiment, the wrist support device further comprises an exterior that is circular along the edges of a longitudinal axis and flat along the interior of the longitudinal axis.

In another embodiment, the wrist support device comprises a smooth exterior surface.

In yet an alternate embodiment, the external pivot joint of the wrist support device is made of one of a durable plastic material, wood, rubber, steel, aluminum, titanium, platinum, gold, silver, metals, or alloy.

In an additional embodiment, the dimensions of the wrist support device could be: (a) a width along the transverse axis of the external pivot joint is between about 1 cm to about 5 cm; (b) a length along a longitudinal axis of the external pivot joint is between about 1.5 cm and 7.5 cm; and (c) a height of the external pivot joint is between about 0.75 cm and 3 cm.

In a separate embodiment, the cushion of the wrist support device is attached to the interior coupling cavity using one of adhesive, tape, hook and loop, or Velcro.

In an alternate embodiment, the cushion of the wrist support device is a gel pad. In one embodiment, the cushion could be a hydrogel or neoprene.

In a yet alternate embodiment, the cushion of the wrist support device is made from a medical grade, water-based hydrogel with a carbon film placed between layers of hydrogel.

In a different embodiment, the wrist support device further comprises a case configured to store the wrist support device and keep the cushion portion free from drying out and collecting dust and particles.

In an alternate method embodiment, there is disclosed a method of providing wrist support comprising the steps of: (a) attaching a wrist support device to a human hand or wrist; and (b) using a keyboard, mouse, game controller, computer peripheral, magic track pad, or writing instrument; wherein the wrist support device is further comprised of: (i) an external pivot joint, wherein the external pivot joint further comprises (a) an exterior that is rounded along at least a transverse axis; (b) a rigid exterior surface; and (c) an interior coupling cavity for attaching a cushion; and (ii) a cushion configured to attach to the interior coupling cavity and to releasably attach to a human hand or wrist.

### BRIEF DESCRIPTION OF THE DRAWINGS

In order that the invention may be more clearly understood, preferred embodiments thereof will now be described in detail by way of examples, with reference to the accompanying drawings, in which:

FIG. 1 is a side view of a human hand depicting how the medial nerve can be impinged in prior art techniques for working on a mouse.

FIG. 2 is an exploded perspective view of the wrist support device and its housing.

FIG. 3 is a perspective view of the wrist support device showing a transverse axis (X) and a longitudinal axis (Y).

FIG. 4A is a front view of the wrist support device looking along the longitudinal axis (Y).

FIG. 4B is a side view of the wrist support device looking along the transverse axis (X).

FIG. 5 is a top view of the housing for the wrist support device.

FIG. 6A is a top view of the wrist support device releasably attached to a human hand.

FIG. 6B is a side view of the wrist support device releasably attached to a human hand while the human hand is engaged in working on a computer mouse.

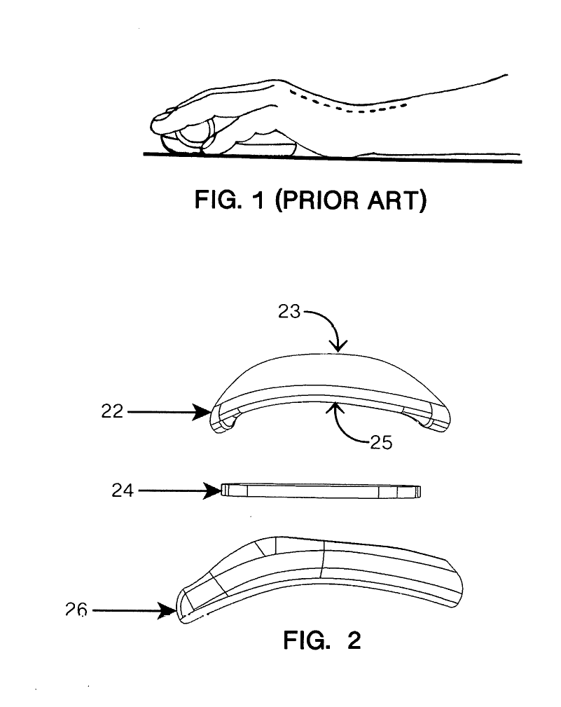

### DETAILED DESCRIPTION

Those of skill in the art will recognize throughout this specification that when like terms are used to describe features and functionalities of various portions of a particular embodiment, those same features and functionalities could be present in additional embodiments having aspects with like terms.

The wrist support device, according to the present invention, releasably attaches to the anterior, or palmar side of the hand, over the flexor retinaculum floor of the carpal tunnel, to provide support thereto by providing a space between the wrist and an underlying surface upon which the wrist is resting. In this way, the alignment of the medial nerve and wrist generally remains linear along an imaginary axis drawn through the center of a user's wrist. The wrist support device thereby maintains the wrist in a neutral position during the performance of tasks such as typing, using a computer mouse, computer peripherals, magic track pad, gaming pieces such as an air hockey paddle or handwriting or drawing with a pen or pencil.

FIG. 2 is an exploded perspective view of the components of the wrist support device 32 as well as a case 26 that may be used when an individual is not wearing the wrist support device 32. The wrist support device 32 is comprised of an external pivot joint 22 and a cushion 24.

As shown in FIG. 2, the external pivot joint 22 has an exterior portion 23, which is generally ovular in shape, and an interior coupling cavity 25, which is configured to act as cavity for affixing the cushion 24. The exterior portion 23 is generally concave and shaped to fit against the palmar surface of the hand and support the anterior side of the wrist and over the carpal tunnel.

With reference to FIGS. 4A and 4B, the exterior portion 23 is generally curved along two axes, the transverse (X) axis and the longitudinal (Y) axis. The curvature along the transverse (X) axis is generally circular, as can be seen in FIG. 4A. The curvature along the longitudinal (Y) axis is circular on the edges with a flat interior portion running along the middle of the longitudinal axis, as can be seen in FIG. 4B. This double curvature permits a user to roll the external pivot joint 22 on a surface to rotate it about the transverse (X) axis to adjust the pitch of the external pivot joint 22, and about the longitudinal (Y) axis to adjust the roll of the external pivot joint 22.

In this way, a user's range of motion is not impeded when switching from using a mouse to a keyboard, for example, or when moving a mouse or game peripheral around a desk or tabletop. The individual wearing the external pivot joint 22 is free to tilt, tip, roll, or pivot his or her hand, which is medically, anatomically and ergonomically beneficial during extended period of use.

The surface of the external pivot joint 22 is smooth to minimize friction between it and a supporting surface such as a desk or tabletop. The smooth surface allows the external pivot joint 22 to easily slide over the supporting surface in such a way that does not interfere with the tasks such as using a keyboard, mouse, magic track pad, game controller, computer peripheral, or writing instrument. In one embodiment, the external pivot joint 22 is made from a durable plastic material, such as polyethylene. In alternate embodiments the external pivot joint 22 could be made from other plastics or similarly rigid materials, such as steel, aluminum, titanium, platinum, gold, silver, or other metals or alloys or wood or rubber.

In terms of the dimensions of the external pivot joint 22, the width along the transverse (X) axis could range from about 1 cm to about 5 cm. The length along the longitudinal (Y) axis could range from about 1.5 cm to about 7.5 cm. The height of the external pivot joint 22 could range from about 0.75 cm to about 3 cm.

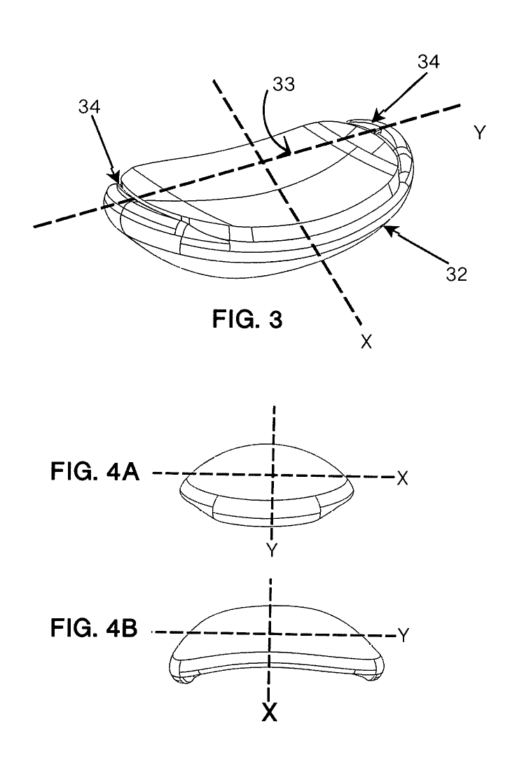

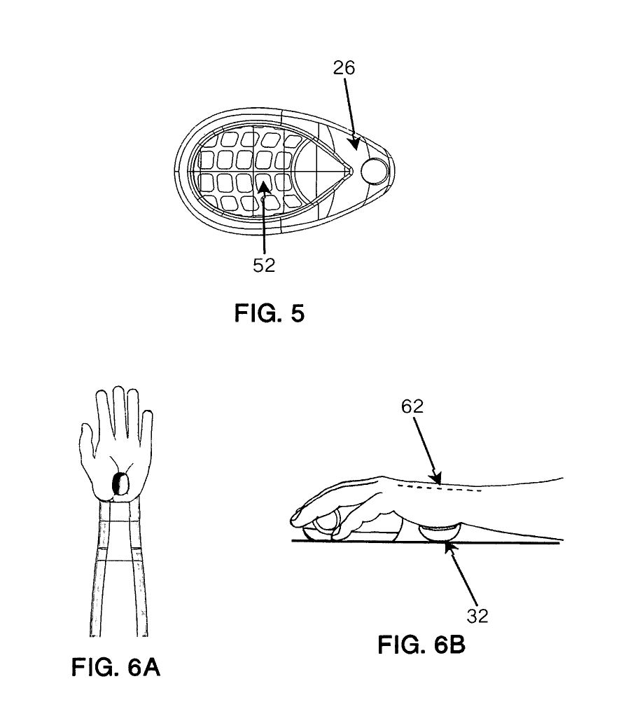

The wrist support device 32 also includes a cushion 24, which is affixed to the interior coupling cavity 25. FIG. 3 shows the cushion 24 affixed to the interior coupling cavity 25. In alternate embodiments, the cushion 24 could be a gel pad made of hydrogel or neoprene. In one embodiment, the cushion 24 could be affixed to the interior coupling cavity 25 with an adhesive such as glue or double sided tape. In most embodiments, it is desirable to replace the cushion 24 periodically because the adhesive used to make the cushion releasably attachable to a human hand will lose its ability to stick to skin over time. Accordingly, the adhesive used to affix the cushion 24 to the interior coupling cavity 25 should be strong enough to hold the cushion 24 in place, but not so strong that it is impossible to remove the cushion 24 in order to replace it with another cushion 24. Alternatively, the cushion 24 could be affixed to the interior couple cavity 25 using hook and loop or Velcro fasteners. In some embodiments, removal tabs could be included with the cushion 24 in order to facilitate easy replacement of the cushion 24.

The cushion 24 could be made of hydrogel, neoprene, or similar materials. In some embodiments, the cushion 24 is a medical grade, water-based hydrogel with a carbon film placed between layers of hydrogel. As can be seen in FIG. 3, the exterior surface 33 of the cushion 24 is flush with the rounded outer edges 34 of the interior coupling cavity 25. This configuration serves at least two purposes: (1) the rounded edges help to secure the cushion 24; and (2) the flush configuration creates a comfortable surface upon which to the user's palm or wrist can rest during use of the wrist support device 32. In alternate embodiments, the exterior surface 33 of the cushion 24 could extend above the height of the rounded outer edges 34 if a user desired additional cushioning or clearance between his or her skin and the body of the external pivot joint 22.

During use, the exterior surface 33 of the cushion 24 can be releasably attached to the anterior side of an individual's hand or wrist. In order for the exterior surface 33 of the cushion 24 to be releasably attachable to an individual's skin, it could include a low level adhesive, such as a medical grade silicone gel adhesive. In one embodiment, the low level adhesive could be a high performance medical grade acrylic adhesive with a polyethylene carrier on a 54# C2S paper differential release liner. Ideally, the exterior surface 33 of the cushion 24 will adhere to the user's skin while simultaneously being easily removable without damaging the user's skin upon removal.

Over time, the adhesive used on the exterior surface 33 of the cushion 24 may lose its ability to stick to a user's skin. When this occurs, a user can replace the cushion 24 by removing it from the interior coupling cavity 25 and replacing the used cushion 24 with a new cushion 24. In some embodiments, the wrist support device 32 can be configured to be stored in a case 26. In some embodiments, the case 26 could be flexible and could be made from an elastomer, such as polyurethane, or other suitable flexible material. The case 26 has an internal opening 52 wherein the wrist support device 32 can be stored when not in use.

In an embodiment, the internal opening 52 is sized so as to securely couple with the exterior surface 33 of the cushion 24, which helps to keep the cushion 24 free from dirt and dust build-up. To the extent that the user properly stores the wrist support device 32 when not in use, he or she will extend the life of the cushion 24 because the adhesive used to create a releasably attachable exterior surface 33 of the cushion 24 will last longer if it is stored in the case 26. Additionally, users can extend the life of the cushion 24 by making sure that the point of attachment of the wrist support device 32 on the skin is clean. Moreover, cushion 24 in some embodiments can be cleaned with soap and water and left to dry before use.

FIG. 6A shows the wrist support device 32 attached to the anterior, or palmar, side of a user's hand. As can be seen in FIG. 6B, when the user is using a mouse with the wrist support device 32 attached to her hand, her wrist remains in proper alignment. Specifically, the axis 62 along with the median nerve would run is linear thus reducing impingement of blood flow throughout the various nerves and veins in the hand. In this way, the user can safely engage in using a keyboard, mouse, computer peripheral, game controller, or writing instrument for extended periods of time without bending or stretching the nerves, tendons, sheaths, and muscles located in the hand, wrist, and forearm.

There is accordingly disclosed methods of using the wrist support device 32 including the steps of attaching the wrist support device 32 to a hand or wrist and using a keyboard, mouse, magic track pad, computer peripheral, game controller, or writing instrument, wherein the wrist support device is comprised of an external pivot joint, wherein the external pivot joint further comprises (a) an exterior that is rounded along at least a transverse axis; (b) a rigid exterior surface; and (c) an interior coupling cavity for attaching a gel pad; and (d) a gel pad configured to attach to the interior coupling cavity and to releasably attach to a human hand or wrist. In an alternate method, a user could attach two wrist support devices 32 to his or her person, one on each hand or wrist, to provide support for both wrists during an activity such as using a keyboard, mouse, game controller, computer peripheral, or writing instrument.

According to these methods of use, the wrist support device 32 is attached to the anterior or palmar side of the hand, over the flexor retinaculum floor of the carpal tunnel, where the wrist support device 32 supports the carpal tunnel and spaces the wrist of the user upwardly apart from a supporting surface, such as a desk or tabletop. The wrist support device 32 thereby maintains the wrist in a neutral position, as shown in FIG. 6B, while the user performs tasks, such as typing, using a computer mouse, computer peripherals, magic track pad, gaming pieces such as an air hockey paddle or handwriting or drawing with a pen or pencil.

According to these method embodiments, an individual's range of motion of the wrist and forearm is preserved by the double curvature of the exterior portion 23, which is generally curved along two axes, the transverse (X) axis and the longitudinal (Y) axis. The curvature along the transverse (X) axis permits adjustment to the roll of the wrist support device 32 as the user tilts his or her forearm from side to side or rotates his or her wrist, while the curvature along the longitudinal (Y) axis permits adjustment in the pitch of the wrist support device 32 as the user tilts his or her forearm forward and backward.

Because the wrist support device 32 is releasably attached to the wrist by an adhesive, there are no straps to interfere with the performance of tasks such as typing, using a computer mouse, computer peripherals, magic track pad, gaming pieces such as an air hockey paddle or handwriting or drawing with a pen or pencil. The wrist support device 32 allows the forearm to move through a wide range of motion by tilting, tipping, or rolling instead of requiring the use of muscle strength. The wrist support device 32 also reduces torque on the wrist at the articulating surfaces between the ulna, radius, and the carpals and reduces flexion, or palmarflexion, and extension, or dorsiflexion, in the wrist, which contribute to repetitive strain and can lead to carpal tunnel syndrome.

The articles “a” and “an” as used herein in the specification and in the claims, unless clearly indicated to the contrary, should be understood to include the plural referents. Claims or descriptions that include “or” between one or more members of a group are considered satisfied if one, more than one, or all of the group members are present in, employed in, or otherwise relevant to a given product or process unless indicated to the contrary or otherwise evident from the context.

The invention includes embodiments in which exactly one member of the group is present in, employed in, or otherwise relevant to a given product or process. The invention also includes embodiments in which more than one or the entire group of members is present in, employed in or otherwise relevant to a given product or process. Furthermore, it is to be understood that the invention encompasses all variations, combinations, and permutations in which one or more limitations, elements, clauses, descriptive terms, etc., from one or more of the listed claims is introduced into another claim dependent on the same base claim (or, as relevant, any other claim) unless otherwise indicated or unless it would be evident to one of ordinary skill in the art that a contradiction or inconsistency would arise.

Where elements are presented as lists, (e.g., in Markush group or similar format) it is to be understood that each subgroup of the elements is also disclosed, and any element(s) can be removed from the group. It should be understood that, in general, where the invention, or aspects of the invention, is/are referred to as comprising particular elements, features, etc., certain embodiments of the invention or aspects of the invention consist, or consist essentially of, such elements, features, etc. For purposes of simplicity those embodiments have not in every case been specifically set forth in so many words herein. It should also be understood that any embodiment or aspect of the invention can be explicitly excluded from the claims, regardless of whether the specific exclusion is recited in the specification. The entire contents of all of the references (including literature references, issued patents and published patent applications and websites) cited throughout this application are hereby expressly incorporated by reference.

Numerous modifications and alternative embodiments of the present invention will be apparent to those skilled in the art in view of the foregoing description. Accordingly, this description is to be construed as illustrative only and is for the purpose of teaching those skilled in the art the best mode for carrying out the present invention. Details of the structure may vary substantially without departing from the spirit of the present invention, and exclusive use of all modifications that come within the scope of the appended claims is reserved. Within this specification, embodiments have been described in a way which enables a clear and concise specification to be written, but it is intended and will be appreciated, that embodiments may be variously combined or separated without departing from the invention. It is intended that the present invention be limited only to the extent required by the appended claims and the applicable rules of law.

What is claimed is:

1. A wrist support device comprising:
a. an external pivot joint, wherein the external pivot joint further comprises (a) an exterior that is rounded along at least a transverse axis; (b) a rigid exterior surface; and (c) an interior coupling cavity; and
b. a cushion configured to attach to the interior coupling cavity and to releasably attach to a human hand or wrist.

2. The wrist support device of claim 1 wherein the curvature along the transverse axis is generally circular.

3. The wrist support device of claim 1 further comprising an exterior that is circular along the edges of a longitudinal axis and flat along the interior of the longitudinal axis.

4. The wrist support device of claim 1 wherein a surface of the exterior is smooth.

5. The wrist support device of claim 1 wherein the external pivot joint is made of one of a durable plastic material, wood, rubber, steel, aluminum, titanium, platinum, gold, silver, metals, or alloy.

6. The wrist support device of claim 1 wherein:
a. a width along the transverse axis of the external pivot joint is between about 1 cm to about 5 cm;
b. a length along a longitudinal axis of the external pivot joint is between about 1.5 cm and 7.5 cm; and
c. a height of the external pivot joint is between about 0.75 cm and 3 cm.

7. The wrist support device of claim 1 wherein the cushion is a gel pad.

8. The wrist support device of claim 7 wherein the gel pad is made of hydrogel or neoprene.

9. The wrist support device of claim 7 wherein the cushion is a medical grade, water-based hydrogel with a carbon film placed between layers of hydrogel.

10. The wrist support device of claim 1 wherein the cushion is attached to the interior coupling cavity using one of adhesive, tape, hook and loop, or Velcro.

11. The wrist support device of claim 1 further comprising a case configured to store the wrist support device.

12. A method of providing wrist support comprising the steps of:
a. attaching a wrist support device to a human hand or wrist; and
b. using a keyboard, mouse, magic track pad, game controller, computer peripheral, or writing instrument; wherein the wrist support device is further comprised of:
i. an external pivot joint, wherein the external pivot joint further comprises (a) an exterior that is rounded along at least a transverse axis; (b) a rigid exterior surface; and (c) an interior coupling cavity for attaching a cushion; and
ii. a cushion configured to attach to the interior coupling cavity and to releasably attach to a human hand or wrist.
